(19) United States
(12) Patent Application Publication
(10) Pub. No.: US 2026/0074363 A1
(43) Pub. Date: Mar. 12, 2026

(54) BATTERY STRUCTURE BODY

(71) Applicant: TOYOTA JIDOSHA KABUSHIKI KAISHA, Toyota-shi (JP)

(72) Inventor: Keisuke UKITA, Toyoake-shi (JP)

(73) Assignee: TOYOTA JIDOSHA KABUSHIKI KAISHA, Toyota-shi (JP)

(21) Appl. No.: 19/225,276

(22) Filed: Jun. 2, 2025

(30) Foreign Application Priority Data
Sep. 10, 2024 (JP) 2024-156855

(51) Int. Cl. H01M 50/367; H01M 50/204; H01M 50/242; H01M 50/249; H01M 50/271

(52) U.S. Cl. CPC H01M 50/367; H01M 50/242; H01M 50/249; H01M 50/271; H01M 50/204; H01M 2220/20

(57) ABSTRACT

There is provided a battery structure body including: a battery stack having a plurality of battery cells stacked in a thickness direction of the battery cells, each of the battery cells having a safety valve on an upper wall of the battery cell; a smoke discharging chamber disposed on an upper side above the battery stack and connected to a smoke discharging duct communicating with an outside of a vehicle cabin; and a plurality of rubber tubes that connects the respective safety valves of the battery cells to the smoke discharging chamber, the rubber tubes extending in an up-down direction.

### CROSS-REFERENCE TO RELATED APPLICATION

This application claims priority to Japanese Patent Application No. 2024-156855 filed on Sep. 10, 2024. The disclosure of the above-identified application, including the specification, drawings, and claims, is incorporated by reference herein in its entirety.

### BACKGROUND

### 1. Technical Field

The present disclosure relates to a battery structure body.

### 2. Description of Related Art

There is conventionally known an exhaust gas tube for discharging, without leakage, hydrogen gas generated inside each of battery units constituting a stacked battery (for example, refer to Japanese Unexamined Patent Application Publication No. 2009-043670 (JP 2009-043670 A)). This exhaust gas tube is constituted of a synthetic resin material with a predetermined inner diameter, and has: safety valve attaching portions that couple with respective exhaust ports of safety valves provided on cases of the battery units; and an exhaust pipe that is communicatively connected to the safety valve attaching portions to guide and release hydrogen gas to the outside. Further, bellows portions that are extendable in the axial direction of the exhaust pipe are provided between the safety valve attaching portions on the exhaust pipe.

### SUMMARY

However, although the exhaust pipe is extendable in the axial direction by virtue of the bellows portions, the safety valve attaching portions which couple with the exhaust ports of the safety valves have poor elasticity and extendibility in the height direction (up-down direction) of a battery stack (stacked battery) having a plurality of battery cells stacked, and vibration of the battery stack in the height direction is difficult to attenuate.

Therefore, an object of the present disclosure is to obtain, with a battery stack having a plurality of battery cells stacked, a battery structure body capable of discharging gas generated inside each of the battery cells to the outside of a vehicle cabin and attenuating the vibration in the height direction.

In order to achieve the aforementioned object, a battery structure body of a first aspect according to the present disclosure includes: a battery stack having a plurality of battery cells stacked in a thickness direction of the battery cells, each of the battery cells having a safety valve on an upper wall of the battery cell; a smoke discharging chamber disposed on an upper side above the battery stack and connected to a smoke discharging duct communicating with an outside of a vehicle cabin; and a plurality of rubber tubes that connects the respective safety valves of the battery cells to the smoke discharging chamber, the rubber tubes extending in an up-down direction.

According to the disclosure of the first aspect, the battery cells having the safety valves on the upper walls are stacked in the thickness direction thereby to constitute the battery stack, and on the upper side above the battery stack, the smoke discharging chamber connected to the smoke discharging duct communicating with the outside of the vehicle cabin is disposed. Further, the safety valves of the battery cells are connected to the smoke discharging chamber with the rubber tubes extending in the up-down direction. Accordingly, gas generated inside each of the battery cells is discharged to the outside of the vehicle cabin via the safety valve, the rubber tube, the smoke discharging chamber, and the smoke discharging duct. Moreover, the rubber tubes function as dampers, and vibration of the battery stack in the height direction is attenuated.

A battery structure body of a second aspect according to the present disclosure is the battery structure body of the first aspect, in addition, the battery stack may be housed in a case having a case body that is open on an upper side, and an upper cover that closes the upper side of the case body, and the upper cover may be attached to the case body in a state of pressing the smoke discharging chamber to the battery stack side.

According to the disclosure of the second aspect, the upper cover of the case in which the battery stack is housed may be attached to the case body in the state of pressing the smoke discharging chamber to the battery stack side. Accordingly, the rubber tubes can be more effectively compressively deformed in the up-down direction, sealability between the rubber tubes and the safety valves can be improved, and functionality of the rubber tubes as dampers can be improved. In other words, vibration of the battery stack in the height direction can be more effectively attenuated.

As above, according to the present disclosure, with the battery stack having the battery cells stacked, gas generated inside each of the battery cells can be discharged to the outside of the vehicle cabin, and the vibration in the height direction can be attenuated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic perspective view showing a battery structure body according to the present embodiment; and

FIG. 2 is a schematic lateral view in which a part of the battery structure body according to the present embodiment is shown as a section.

### DETAILED DESCRIPTION OF EMBODIMENTS

Hereafter, embodiments according to the present disclosure will be described in detail based on the drawings. Note that, for convenience of description, an arrow UP, properly indicated in the figures, is regarded as an upper direction of a battery structure body, an arrow FR is regarded as a front direction of the battery structure body, and an arrow RH is regarded as a right direction of the battery structure body. Accordingly, in the following description, when the up-down, front-rear, and left-right directions are described without being particularly noted, those are supposed to specify the up-down, front-rear, and left-right directions regarding the battery structure body, respectively, but are not specially limited to these directions.

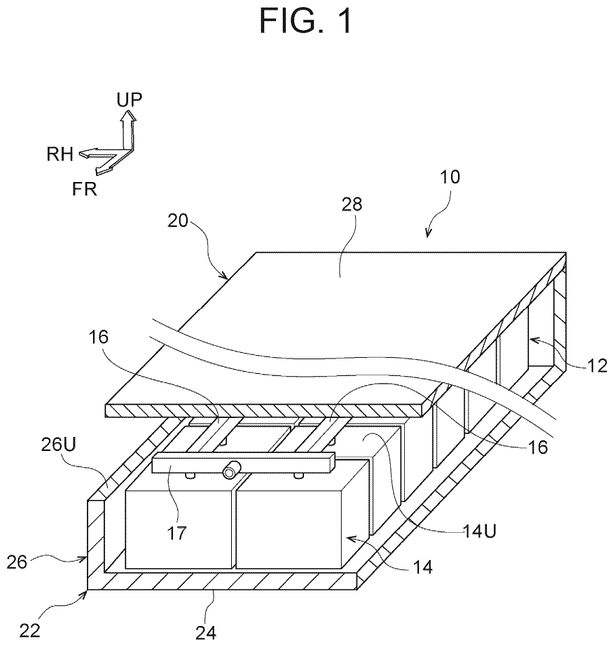

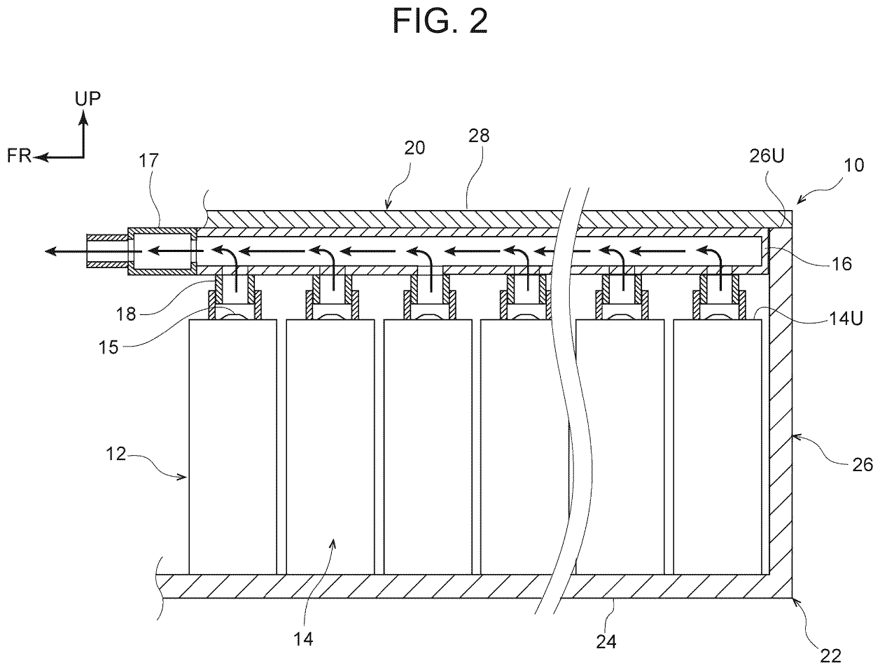

As shown in FIG. 1 and FIG. 2, a battery structure body 10 according to the present embodiment is to be mounted on a vehicle (illustration of which is omitted), such as a battery electric vehicle which travels with electricity as a motive power source, and includes: battery stacks 12 each having a plurality of battery cells 14 stacked in a thickness direction (the front-rear direction); and a case 20 that houses a plurality of columns of the battery stacks 12 in the left-right direction.

Safety valves (smoke discharging valves) 15 are provided on respective upper walls 14U of the battery cells 14, and resin-made smoke discharging chambers 16 extending in the thickness direction of the battery cells 14 are arranged on an upper side above the battery stacks 12. Each of the smoke discharging chambers 16 is formed to be hollow in a substantially rectangular shape in sectional view perpendicular to the extending direction (thickness direction of the battery cells 14), and is arranged for corresponding one of the columns of the battery stacks 12 that are arranged side by side in the left-right direction.

Further, with and to each of the safety valves 15 of the battery cells 14, a lower end portion of a cylindrical rubber tube 18 extending in the up-down direction is in close contact (has sealability) and is communicatively connected, and an upper end portion of each of the rubber tubes 18 is in close contact (has sealability) with and is communicatively connected to corresponding one of the smoke discharging chambers 16. Moreover, a smoke discharging duct 17 that communicates with the outside of a vehicle cabin is communicatively connected in a sealed manner to one end portion of each smoke discharging chamber 16 in the extending direction. Note that the smoke discharging chambers 16 and the rubber tubes 18 preferably have a unit structure in which he smoke discharging chambers 16 and the rubber tubes 18 have already been connected together beforehand.

The case 20 has a case body 22 that is open on an upper side, and an upper cover 28 that closes the upper side of the case body 22. That is, the case body 22 has a substantially rectangular flat plate-shaped bottom wall 24, and a substantially rectangular flat plate-shaped circumferential wall 26 integrally standing with a predetermined height from the circumferential edge portion of the bottom wall 24. The upper cover 28 is configured to be fastened and fixed to an upper end surface 26U of the circumferential wall 26 in the state where the circumferential edge portion of the upper cover 28 is brought into contact with the upper end surface of the circumferential wall 26, and there is employed a configuration in which the attachment to the case body 22 can be performed in the state where the smoke discharging chambers 16 are pressed to the side of the battery stacks 12.

That is, the height of the circumferential wall 26, the height (thickness) of the smoke discharging chambers 16, and the height (length in the up-down direction) of the rubber tubes 18 relative to the height of the battery cells 14, and the like are set such that the upper cover 28 can press the battery stacks 12 downward via the smoke discharging chambers 16 (such that the battery stacks 12 can be pressed onto the bottom wall 24 of the case body 22). In other words, the heights and the like are set such that the rubber tubes 18 take a state of being elastically deformed (compressively deformed) by a predetermined amount in the up-down direction (axial direction).

With the battery structure body 10 according to the present embodiment having the configuration as above, operation thereof is next described.

As described above, the battery stacks 12 are configured by the battery cells 14 being stacked in the thickness direction, the battery cells 14 having the safety valves 15 on the upper walls 14U, and on the upper side above the battery stacks 12, the smoke discharging chambers 16 connected to the smoke discharging duct 17 communicating with the outside of the vehicle cabin are arranged. Further, the safety valves 15 of the battery cells 14 and the smoke discharging chambers 16 are connected with the rubber tubes 18 extending in the up-down direction.

Accordingly, when gas is generated inside the battery cells 14, as indicated by the arrows in FIG. 2, the gas is discharged to the outside of the vehicle cabin via the safety valves 15, the rubber tubes 18, the smoke discharging chambers 16, and the smoke discharging duct 17. Moreover, the rubber tubes 18 can be elastically deformed in the up-down direction (axial direction), and hence, function as dampers. Therefore, in traveling of the vehicle, and the like, vibration of the battery stacks 12 in the height direction can be attenuated (reduced).

Moreover, the upper cover 28 of the case 20 housing the battery stacks 12 is attached to the case body 22 in the state of pressing the smoke discharging chambers 16 to the side of the battery stacks 12. Accordingly, the rubber tubes 18 are more effectively compressively deformed (elastically deformed) in the up-down direction (axial direction), sealability between the rubber tubes 18 and the safety valves 15 can be improved, and functionality of the rubber tubes 18 as dampers can be improved. Therefore, vibration of the battery stacks 12 in the height direction can be more effectively attenuated (reduced).

As above, while the battery structure body 10 according to the present embodiment has been described based on the drawings, the battery structure body 10 according to the present embodiment is not limited to illustrated one, and its design can be properly modified without departing from the spirit of the present disclosure. For example, the number of columns of the battery stacks 12 housed in the case 20 are not limited to two as illustrated, and the number of the battery cells 14 that constitute each of the battery stacks 12 is not specially limited.

What is claimed is:

1. A battery structure body comprising:
a battery stack having a plurality of battery cells stacked in a thickness direction of the battery cells, each of the battery cells having a safety valve on an upper wall of the battery cell;
a smoke discharging chamber disposed on an upper side above the battery stack and connected to a smoke discharging duct communicating with an outside of a vehicle cabin; and
a plurality of rubber tubes that connects the respective safety valves of the battery cells to the smoke discharging chamber, the rubber tubes extending in an up-down direction.

2. The battery structure body according to claim 1, wherein:
the battery stack is housed in a case having
a case body that is open on an upper side of the case body, and
an upper cover that closes the upper side of the case body; and
the upper cover is attached to the case body in a state of pressing the smoke discharging chamber to the battery stack side.
